(19) United States
(12) Patent Application Publication
(10) Pub. No.: US 2004/0042950 A1
(43) Pub. Date: Mar. 4, 2004

(54) Method for producing high-purity, granular silicon

(76) Inventors: Leslaw Mleczko, Bochum (DE); Sigurd Buchholz, Koln (DE); Oliver Felix-Karl Schluter, Dusseldorf (DE); Maria Pilar Tejero Ezpeleta, Leverkusen (DE)

Correspondence Address: MCGLEW & TUTTLE, PC, 1 SCARBOROUGH STATION PLAZA, SCARBOROUGH, NY, 10510-0827, US

(21) Appl. No.: 10/416,627

(22) PCT Filed: Nov. 7, 2001
(86) PCT No.: PCT/EP01/12846

(30) Foreign Application Priority Data
Dec. 6, 2000 (DE) 100-60-469.2

(51) Int. Cl. C01B 33/023

(52) U.S. Cl. 423/349

(57) ABSTRACT

The invention relates to a method for producing hyper-pure granular silicon by decomposing a silicic gas in a reactor consisting of a metallic material. Said reactor is provided with a protective layer of silicon on the side thereof facing the product. The surface of the protective layer is continuously renewed by silicon deposition during the decomposition of the silicic gas, and the diffusion of impurities in the silicon produced is minimised to such an extent that high-purity silicon is obtained, suitable for use in the photovoltaic or semiconductor industry. The invention also relates to a reactor consisting of a metallic material and provided on the inside with a protective layer of silicon, the surface of said layer being continuously renewed during the operation of the reactor. The invention further relates to the use of the reactor for carrying out a method for producing high-purity granular silicon by decomposing a silicic gas.

The present invention relates to a method for producing hyper-pure granular silicon by decomposition of silicic gases. Furthermore, the invention relates to an apparatus for the execution of this method and the application of such apparatus.

Silicic gases as referred to herein are silicon compounds or mixtures of silicon compounds which under the conditions according to the invention can be decomposed in the gaseous phase depositing silicon. Silicon-free gases in the meaning of this invention are gases which do not contain any silicon compounds.

For applications in the photovoltaic area and the manufacture of electronic components silicon of a particularly high purity is required.

For the production of such silicon methods of thermal decomposition of volatile silicon compounds are known. Such thermal decomposition can be carried out, for example, in fluidized-bed reactors in that small silicon particles are provided which are then fuidized by an appropriate silicic gas or gas mixture flowing into the reactor, whereby the gases in the gas mixture can be silicic, but also silicon-free gases.

In order to obtain silicon of the desired high purity, components from the reactor shell must be prevented from entering the reaction chamber and contaminating the produced silicon.

To this end, the employed reactors are usually provided with an inliner (an inserted reaction pipe) made of inert or pure material, or with a coating on their interior surface, particularly with a silicon or silicon carbide coating.

For example it was suggested for thermal decomposition of monosilane to polycrystalline silicon, to work in a reactor with an interior surface rendering a maximum impurity content of 300 ppm up to a depth of 20 μm, and that each individual contaminating element contained in this layer is present in a concentration of not more than 100 ppm (Chemical Abstracts CA, no. 112 663s, 1994). In another place an impurity content of not more than 10 ppm is allowed in the interior surface of the reactor up to a depth of 20 μm (Chemical Abstracts CA, no. 112 662r, 1994).

From DE 38 39 705 A1 it is known to employ reactors provided with an inert inner coating, i.e. with an inliner, particularly made of graphite. The inert inner coating serves on the one hand to reduce the contamination of the silicon and on the other hand to protect the heating system provided in the interior of the reactor against contact with the reactants in the reaction chamber. It is pointed out that if an inert inner coating is provided it may be possible that the reaction chamber cannot be closed hermetically at its periphery, which may lead to reactants escaping from the reaction zone. To avoid this problem, additional measures must be taken, for example adjustment of a pressure difference from the reactor wall to the reaction zone. This increases the required industrial instrumentation considerably.

So the application of inliners requires considerably higher structural efforts, particularly as far as sealing of the inliner is concerned. There is further the risk that due to different thermal expandability factors the inliner may be damaged by the silicon deposited on the inliner during the process.

Reactors made of graphite or silica glass, for example, can be operated without inliners. The application of such reactors, however, is disadvantageous for the industrial production of hyper-pure granular silicon by decomposition of silicic gas, because the possible reactor size is strongly limited by the respective material properties. In addition to this, gasproofness of graphite can only be achieved by means of the appropriate coatings.

Such problems do not occur in reactors made of metallic materials. However, for reactors made of metallic materials, such as for example special steel, it is described in the relevant literature that due to the diffusion of foreign metals contaminations are transferred to the material in the reactor. In a report from Jet-Propulsion Laboratory (DOE/JPL-1012-123; N. K. Rohtagi, 1986, p. 16-17) it is described for example, that the strongest contamination and thus the strongest transfer of contamination to the produced silicon occurs in the hot reactor.

The object of the present invention was to provide a method for the manufacture of hyper-pure granular silicon by decomposition of a silicic gas which can be carried out in a reactor made of a metallic material, wherein no contamination of the produced silicon by components from the reactor material occurs.

Subject-matter of the invention is a method for the manufacture of hyper-pure granular silicon by decomposition of a silicic gas carried out in a reactor made of a metallic material, characterized in that the reactor is provided with a protective coating consisting of silicon on the surface facing the product, and that the surface of that coating is permanently renewed during the decomposition of the silicic gas.

During the execution of the method according to the invention in the employed reactor made of a metallic material, a silicon layer deposits on the interior reactor surface during thermal decomposition of a silicic gas to silicon, and while the surface of the silicon layer facing the reactor wall is contaminated by foreign atoms diffusing from the reactor wall into the silicon, the surface of the silicon layer facing the product is surprisingly free of any contamination on the surface. So although metallic materials are used no contamination of the silicon produced inside the reactor occurs. Further it was found that during the formation of the silicon layer the reactor material used is not damaged.

The method according to the invention can be carried out in different types of reactors, provided that inside the reactor a protective silicon layer according to the invention forms on the reactor surface facing the product.

Appropriate reactors, particularly fluidized-bed reactors are already known. The application of a fluidized-bed reactor is preferred. By way of example reactors providing a bubbling or circulating fluidized bed may be mentioned, further spouted bed reactors, moving bed reactors and downpipe reactors.

The method can be carried out, for example, continuously or discontinuously. A continuous process is preferred.

The reactor dimensions can be largely varied as the metallic material to be used (e.g. special steel), unlike materials such as graphite or silica glass, is not restricted in terms of availability and is moreover known for its special stability. So for example the dimensions can be optimally adjusted to the desired reaction conditions. The method according to the invention can be easily carried out, for example, at a temperature of 650° C. and a pressure of approx. 1100 mbar in a cylindrical reactor made of a thermoresistant metallic material with a diameter of approx. 2000 mm and a wall thickness of approx. 15-20 mm. Such reactor diameters cannot be realized, for example, when reactors made of quartz or graphite are employed.

Suitable metallic materials are thermoresistant metallic materials and alloys, e.g. steels. The material needs to be selected depending on temperature, the resistance of the material towards the reaction media (particularly H₂ at high temperatures) and the required pressure rating. Preferably austenitic steels are used, such as e.g. 1.4981, 1.4961 or high-temperature Cr—Ni steels, particularly preferred Alloy 800 H.

It is also possible to use a reactor that is not exclusively made of one of the metallic materials specified above, but comprises a pressure vessel and/or thermoresistant container the interior of which is coated with the metallic material.

Apart from this, it is also possible that the interior of the metallic reactor be provided with a ceramic and/or oxidic coating acting as a diffusion barrier against the transfer of contamination from the reactor wall into the protective silicon layer.

Preferably a metallic reactor consisting completely of the specified metallic material is employed.

According to the invention the decomposition of a silicic gas to crystalline silicon is carried out in a reactor provided with a protective coating consisting of silicon on the surface facing the product, and the surface of such coating is permanently renewed during the decomposition of the silicic gas. The reactor surface facing the product can be coated with the protective silicon coating during the decomposition of the silicic gas to hyper-pure granular silicon.

It is also possible, however, to apply the protective coating prior to the actual reaction of a silicic gas to hyper-pure granular silicon, e.g. during the start-up phase of the reactor. In that case, for example, silicic gas is thermally decomposed in the empty reactor, heating the reactor wall up to a temperature that leads to the decomposition of silicic gas and thus to the deposition of silicon on the reactor wall. The temperature depends on the silicic gas employed and can be varied, for example, in a temperature range from 300° C. to 1400° C. The temperature must be high enough, however, to ensure the decomposition of the silicic gas and must not exceed the melting temperature of the produced silicon. In case of SiH₄ being used as silicic gas the advantageous temperature range is between 500° C. and 1400° C. A decomposition temperature from 600° C. to 1000° C. is preferred, particularly preferred 620° C. to 800° C. In case of SiI₄ being used the respective range is between 850° C. and 1250° C., for other halosilanes between 500° C. and 1400° C.

It is preferred that the protective silicon layer be applied during the decomposition of silicic gas to multicrystalline silicon.

The method according to the invention is carried out such that the surface of such coating is permanently renewed during the decomposition of the silicic gas.

To this end, it is possible, for example, to provide a certain amount of seed crystal in the reactor and to run the reactor at a temperature at which the decomposition of silicic gas occurs. When introducing the silicic gas into the reactor for decomposition, the silicon that is formed by decomposition deposits on the nucleation particles and the interior reactor surface. During the decomposition reaction again and again silicon deposits on the silicon layer on the interior reactor surface thus forming the permanently renewing protective silicon layer. It is also conceivable, however, that the interior surface of a reactor is coated with a first silicon layer at a temperature above the decomposition temperature of the employed silicic gas by introducing silicic gas and deposition of the silicon formed on the wall. Then, (without prior cooling of the reactor) the nucleation particles are introduced into the pretreated reactor and the decomposition is carried out as specified above under permanent renewal of the silicon layer.

The reaction velocity, i.e. the deposition velocity of silicon on the reactor surface, must be controlled such that the silicon layer grows faster than a critical concentration of contamination can diffuse through and up to the surface of this layer.

The required reaction velocity can be adjusted, for example, by ensuring a high concentration of silicic gas in the gas that is introduced into the reactor, preferably >5 volume percent, particularly preferred >15 volume percent, and/or by ensuring that the temperature of the reactor surface is higher than the temperature in the interior of the reactor, preferably 2-200° C. higher, particularly preferred 5-80° C. higher.

Silicic gases to be employed in the method according to the invention can be, for example, silanes, silicon iodides and halosilanes of chlorine, bromine and iodine. Also mixtures of the named compounds can be employed. It is irrelevant whether the silicon compound is already rendered in gaseous form at room temperature or needs to be transformed into gaseous condition first. The transformation to gaseous condition can be carried out thermally for example. The use of silanes is preferred. By way of example SiH₄, Si₂H₆, Si₃H₈, Si₄H₁₀ and Si₆H₁₄ may be named. Particularly preferred is SiH₄.

The pressure prevailing during the execution of the method according to the invention is largely uncritical. It is preferred, however, to work at pressures from 50 to 50000 mbar, preferably 100 to 10000 mbar, particularly preferred 200 to 6000 mbar. All pressure values specified refer to the absolute pressure. If the method according to the invention is carried out in a fluidized-bed reactor the pressure specified above is to be understood as the pressure prevailing behind the fluidized bed as seen in flow direction of the introduced gas mixture.

It is possible to carry out the method according to the invention for the manufacture of hyper-pure granular silicon by adding a silicon-free gas or a mixture of several silicon-free gases. For example, the amount of silicon-free gas added can be 0 to 98 volume percent based on the total amount of gas introduced. Adding silicon-free gas and/or a mixture of silicon-free gases has an impact on the formation of silicon dust upon thermal decomposition of the silicic gas. It is also possible, however, to do without any addition of silicon-free gas.

Suitable silicon-free gases are, for example, the noble gases, nitrogen and hydrogen, the silicon-free gases being applicable each gas individually or any combination of them. Nitrogen and hydrogen are preferred, particularly preferred is hydrogen.

Temperature can be varied in the temperature range from 300° C. to 1400° C. The temperature must be high enough, however, to ensure the decomposition of the silicic gas and must not exceed the melting temperature of the produced silicon. In case of SiH4 being used the advantageous temperature range is between 500° C. and 1400° C. A decomposition temperature from 600° C. to 1000° C. is preferred, particularly preferred 620° C. to 800° C. In case of SiI₄ being used the respective range is between 850° C. and 1250° C., for halosilanes between 500° C. and 1400° C.

The produced hyper-pure granular silicon can be discharged from the used reactor, for example, continuously or intermittently.

In a preferred embodiment of the method according to the invention solid particles are provided in the reactor zone of a fluidized-bed reactor, hereinafter referred to a particles. These particles can be introduced from the exterior continuously or intermittently. These particles can also be particles which are generated in the reaction zone. The particles form a fixed bed through to which the introduced gas is streamed from below. The stream-in velocity of the introduced gas is adjusted such that the fixed bed is fluidized and a fluidized bed develops. The respective procedure is generally known to the skilled person. The stream-in velocity of the introduced gas must correspond to at least the loosening velocity. Loosening velocity in this case is to be understood as the velocity at which a gas streams through a bed of particles and below which the fixed bed is maintained, i.e. below which the bed particles remain largely fixed. Above this velocity the bed starts fluidizing, i.e. the bed particles move and bubbles begin to emerge. The stream-in velocity of the introduced gas in this preferred embodiment is one to ten times the loosening velocity, preferably one and a half to seven times the loosening velocity. Preferably particles of a diameter of 50 to 5000 μm are used.

The particles used are preferably silicon particles of a purity corresponding to the one desired for the produced hyper-pure granular silicon.

The silicon produced according to the invention is suitable for multiple purposes. For example, the application of the produced silicon in the photovoltaic area or in the manufacture of electronic components can be mentioned.

Subject-matter of the invention is furthermore a reactor made of a metallic material, characterized in that the interior of the reactor is provided with a protective layer consisting of silicon the surface of which is permanently renewed during operation of the reactor.

Preferably the reactor according to the invention is a fluidized-bed reactor.

The reactor dimensions can be largely varied as the metallic material to be used (e.g. special steel), unlike materials such as graphite or silica glass, is not restricted in terms of availability and is known for its special stability. So for example the dimensions can be optimally adjusted to the desired reaction conditions.

For example, the reactor has a cylindrical form with a cylinder diameter between 25 mm to 4000 mm, preferably 100 mm to 3000 mm. The material to be selected and the wall thickness depend on the range of temperatures and pressures used.

The height of the reactor is for example from 0.1 m to 20 m, preferably from 0.5 m to 15 m.

Suitable metallic materials are the same as specified in the description of the method according to the invention. The maximum tolerable content of contamination in the reactor material may clearly exceed the maximum tolerable content of contamination in the product to be produced, because the protective layer on the interior surface of the reactor prevents a transfer of contamination from the reactor material to the product.

The protective layer on the interior surface of the reactor can be applied, for example, by decomposition of silicic gas to crystalline silicon in the reactor.

Preferably the reactor according to the invention is used in a method for producing hyper-pure granular silicon by decomposition of silicic gases, but also other applications are conceivable.

Subject-matter of the invention is therefore furthermore the application of the reactor according to the invention for the execution of a method for the manufacture of hyper-pure granular silicon by decomposition of silicic gas.

### EXAMPLE 1

In a fluidized-bed reactor made of thermoresistant steel 1.4959 (diameter=52.4 mm, height with head extended=1600 mm), 800 g of silicon particles with an average diameter of 346 μm (particles diameter Dp=250-400 μm) were provided. The reaction was carried out at a pressure of 500 mbar at the head of the reactor. After start-up and heating of the fluidized bed to a temperature of 680° C. in nitrogen, the silane concentration (SiH₄) at the entrance of the reactor was adjusted from 0 to 100 volume percent based on the fluidizing gas nitrogen. Then a percentage of 30 volume percent hydrogen (H₂) based on silane (SiH₄) was adjusted. The silane decomposed to silicon which deposited on the silicon particles and the interior surface of the reactor. After a total period of 120 min (40 min adjustment of the specified concentration and 80 min stationary operation), the particles which had grown from an average diameter of 346 to 378 μm due to the deposition of silane (SiH₄) were allowed to cool and were then discharged from the reactor. During the reaction, a silicon layer had formed on the interior surface of the reactor. Altogether 466 1 (standard conditions) of silane were reacted during the experiment 2.1% of which deposited on the reactor wall in form of silicon. The thickness of the deposited layer was 190±49 μm as determined by means of representative samples.

In order to allow examination of the properties and purity of the silicon layer formed during the reaction on the interior surface of the reactor, parts of the silicon layer were removed from the reactor and examined by means of electron microscopy and Energy Disperse X-ray Spectroscopy (EDX). Examination by means of electron microscopy shows that a compact layer of silicon grows on the interior surface of the reactor.

The examinations by means of energy-disperse X-ray spectroscopy (EDX) showed that the main contaminating elements are iron (Fe), chrome (Cr) and nickel (Ni), which elements were detected on that side-of the silicon layer that is in contact with the reactor wall. No signals caused by contamination could be detected, however, on the side of the silicon layer facing the reactor zone.

1. A method for the manufacture of hyper-pure granular silicon by decomposition of a silicic gas carried out in a reactor made of a metallic material, characterized in that the reactor is provided with a protective coating consisting of silicon on the surface facing the product, and that the surface of that coating is permanently renewed during the decomposition of the silicic gas.

2. A method according to claim 1, characterized in that the permanent renewal of the surface of the protective coating consisting of silicon is achieved by a high deposition velocity of silicon on the inner reactor surface, wherein the silicon layer on the reactor surface grows faster than contamination in critical concentration can diffuse through and up to the surface of this layer.

3. A method according to at least one of claims 1 and 2, characterized in that the concentration of silicic gas in the gas that is introduced into the reactor is >5 volume percent and/or that the temperature of the reactor surface is higher than the temperature in the interior of the reactor.

4. A method according to at least one of claims 1 to 3, characterized in that the metallic material used is austenitic steel or a high-temperature Cr—Ni steel.

5. A method according to at least one of claims 1 to 4, characterized in that the reactor is made of a metallic material and comprises a pressure vessel and/or thermoresistant container the interior of which is coated with the metallic material.

6. A method according to at least one of claims 1 to 5, characterized in that the reaction is carried out at a pressure ranging from 50 to 50000 mbar.

7. A method according to at least one of claims 1 to 6, characterized in that the decomposition of a silicic gas is carried out in the presence of particles through which the introduced gas streams in a way such that the particles are fluidized and a fluidized bed develops.

8. A method according to claim 7, characterized in that the particles have a diameter between 50 and 5000 μm.

9. A method according to at least one of claims 1 to 8, characterized in that the silicic gas used is silane, preferably SiH₄.

10. A method according to at least one of claims 1 to 9, characterized in that prior to the manufacture of hyper-pure granular silicon in the reactor an initial protective coating consisting of silicon is formed on the reactor surface facing the product by reaction of a silicic gas.

11. Use of the silicon produced according to at least one of claims 1 to 10 in the photovoltaic area.

12. Use of the silicon produced according to at least one of claims 1 to 10 in the manufacture of electronic components.

13. A reactor made of a metallic material, characterized in that the interior of the reactor is provided with a protective layer consisting of silicon the surface of which is permanently renewed during operation of the reactor.

14. Use of the reactor according to claim 13 for the execution of a method for the manufacture of hyper-pure granular silicon by decomposition of silicic gas.
